(19) United States
(12) Patent Application Publication
(10) Pub. No.: US 2009/0019429 A1
(43) Pub. Date: Jan. 15, 2009

(54) Virtualization of data source components in subject-oriented graphical programming environments for test and measurement applications

(76) Inventors: Andreas Randow, Cambridge, MA (US); Brian Wessels, Westminster, MA (US)

Correspondence Address: PHILIP KOENIG;PITTAS // KOENIG, P.O. BOX 980, WINCHESTER, MA, 01890, US

(21) Appl. No.: 11/827,735

(22) Filed: Jul. 14, 2007

(51) Int. Cl. G06F 9/44

(52) U.S. Cl. 717/130

(57) ABSTRACT

A subject-oriented graphical programming environment, for the design and construction of virtual instrumentation systems, comprises means enabling the visualization of data sources, control sources, data sinks, and events, thereby maximizing hardware device interchangeability and allowing device simulation. Said means comprise a decoupling software layer for decoupling the data connection aspects of a development environment from its visualization, data processing and control components. The decoupling layer comprises a “Jack” component type, to interface with the data connection components of an application, linkable to a “Plug” type component that interfaces with the rest of the application. Jack and Plug components are configurable by application developers using graphical tools, providing users with broad discretion to define their own data acquisition virtual interfaces, rather than being limited to using an existing data connection component directly.

### FIELD OF THE INVENTION

The present invention concerns graphical software development environments, and it is more particularly directed to the provision, in a subject-oriented graphical programming environment for the design and construction of virtual instrumentation systems, of means enabling the virtualization of data sources, control sources, data sinks, and events, thereby to maximize hardware interchangeability and allow simulation.

### PRIOR APPLICATIONS

The present application incorporates previously filed Application for patent Ser. No. 10/230,412 filed Aug. 22, 2002, and previously filed Application for patent Ser. No. 10/764,690 filed Jan. 26, 2004.

### BACKGROUND

The present invention concerns computer software that is used to create and operate “virtual instrumentation systems.” That is, the invention concerns computer software that a user would employ to develop a computerized test and measurement system, for controlling from a computer desktop one or several external measurement hardware devices and for displaying, on instrument-like panels on a computer screen, test or measurement data collected by the external devices, and possibly also for controlling processes based on data collected and processed by the instrumentation system.

In particular the present invention is an improvement to “subject-oriented” graphical development environments for test and measurement applications, exemplified by the Measure Foundry® graphical development software marketed by Data Translation, Inc. of Marlboro, Mass., that is described in U.S. patent application Ser. No. 10/230,412 filed Aug. 22, 2002.

An instrument is a device designed to collect data from an environment, or from a unit under test, and to display information to a user based on the collected data. Such an instrument may employ a transducer to sense changes in a physical parameter, such as temperature or pressure, and to convert the sensed information into electrical signals, such as voltage or frequency variations. The term instrument may also cover, and for purposes of this description it will be taken to cover, a physical or software device that performs an analysis on data acquired from another instrument and then outputs the processed data to display or recording means. This second category of instruments would for example include oscilloscopes, spectrum analyzers and digital multi-meters.

Until the recent past, instrumentation systems have generally consisted of individual instruments, such as an electromechanical pressure gauge comprising a sensing transducer wired to signal conditioning circuitry, outputting a processed signal to a display panel and perhaps also to a line recorder, in which a trace of changing conditions is inked onto a rotating drum by a mechanical arm, creating a time record of pressure changes.

With the introduction of computers into the field of instrumentation, individual physical instruments, such as pressure sensors or thermometers, were linked to a computer, using “instrumentation” software developed to enable the display of measurement data on a “virtual” instrument panel, painted in software on the computer monitor, and usually also containing user-operable buttons, sliders or other like means for controlling the operation of the sensing device. Over time, a large variety of data collection instruments designed specifically for computerized control and operation have been developed, along with increasingly sophisticated “instrumentation software” for communicating with and controlling such devices, creating the field now called “virtual instrumentation.”

The term “virtual instrumentation” refers in particular also to the development and construction of computerized systems that combine data collection hardware devices and virtual instrumentation software into an integrated instrumentation system. In such a system, one or a plurality of data collection hardware devices (typically incorporating sensing elements for detecting physical changes in the conditions of test subjects) are coupled to a computer via a bi-directional connection, and a software application precisely tailored to the characteristics of the sensors, and to the needs of a user, enables the output of the data collection devices to be displayed on the computer screen, under the control of the user, on displays that simulate the appearance of the dials, meters and other data visualization devices of traditional instruments.

Virtual instrumentation systems typically also comprise pure software “instruments”, such as oscilloscopes and spectrum analyzers, for processing the collected sensor data and “massaging” it in ways useful to the users of the data. For example, software means may be employed to analyze collected data as needed to present the user with isolated information on “max” or “min” readings, averages, standard deviations, or combinations of results from related sensing points, etc.

The development of virtual instrumentation systems has faced challenging technical difficulties, principally including complex technical issues raised by the great variety of data collection hardware devices that are commercially available: the data collecting hardware devices that one user may want to incorporate into a single “virtual instrumentation system” may easily include a plurality of devices, built by different manufacturers, that have very different internal structures and functions, and that consequently employ different interfaces and different command sets. Any graphical development software marketed as suitable for building such virtual instrumentation systems must necessarily comprise software tools capable of communicating effectively with each of the disparate types of hardware devices that may be employed by any such application.

For example, some data acquisition devices are so-called “register-based” instruments, controlled by streams of 1s and 0s sent directly to control components within the instrument; others are “message-based” instruments, and are controlled by “strings” of ASCII characters, effectively constituting written instructions that must be decoded within the instrument. In addition, different instruments use different protocols to output data, some as electrical frequencies and others as variations in a base voltage, for example.

The software that is used to control any one type of instrument is referred to as “instrument driver” software. For a computerized instrumentation system to operate, means must generally be provided, usually in the form of “libraries” of instrument driver software, to deal with the different ways used by the external instruments to communicate with a computer host.

Initially the programming of virtual instrumentation systems was a task for professional programmers, who wrote the required software programs using “textual” programming languages such as BASIC, C++, or PASCAL, in a very time consuming process. Beginning in about 1990, however, several software products for the development of virtual instrumentation systems using purely graphical programming methods have become available, including the HP VEE software marketed by Hewlett-Packard, the LabVIEW products marketed by the National Instruments Company, and the Measure Foundry® software marketed by Data Translation, Inc.

Each of these products provides users, including users who are not skilled software programmers, with a “graphical development environment” within which to design a custom virtual instrumentation system. Typically the user is presented with a “design desktop” environment, generally having the look-and-feel familiar to users of Windows-based graphical applications, from within which a variety of software options and “tools” are accessible, from toolbars and dialog boxes featuring drop-down menus, and may be accessed by manipulating an on-screen cursor using a computer mouse.

Of the known software products for developing virtual instrumentation systems using graphical programming means, most are based on providing the user with tools for designing so-called “data flow” diagrams of an intended application. A user of these products builds an instrumentation system by placing icons representing desired system components onto a design desktop, and then proceeding to “wire” connections between components with the cursor, a task that requires a firm understanding of the specific data paths and element combinations required to effectuate the user's objective (to wit, a “solution” to the users measurement requirements). It is a drawback of these products that they generally allow a user unwittingly to wire together components that are functionally incompatible.

The Measure Foundry software product differs from the “Wiring diagram” products of the prior art in that it employs a “subject-oriented” architecture, which makes it possible to present users with only compatible design selections among combinations of data source hardware devices, data processing tools, visualization devices, and control tools.

The present invention is addressed principally to a subject-oriented graphical development environment like the Measure Foundry system, and it provides means, in such a system, for the virtualization of data sources, control sources, and data sinks, to make possible full hardware interchangeability and simulation. However the present invention is believed also to be adaptable for use in graphical test and measurement development environments that employ a “wiring diagram” approach, though embodiments of the invention for such applications have not been fully defined and developed at the present time.

A subject-oriented graphical development system like Measure Foundry has a “design mode” that presents the user with a “design desktop” on which, by using “drag and drop” and like graphical tools and techniques, the user may place and develop a plurality of components to represent an instrument. Further, one such instrument can be organized with other, similarly constructed instruments, to form a group to constitute all of the instrumentation of a multi-instrument test or measurement application. For example, one component may constitute a temperature gauge, associated with a control component containing “start and “stop” buttons, a digital display component to display the currently measured temperature, and a line recorder component that displays temperature variations over selected periods of time.

A user setting out to build an instrumentation application will thus place on the design desktop a set of instrument components that the user has selected from functionally distinct groups of available components, and then combine the selected components into a complete virtual instrument. Preferably three principal groups of instrument components are provided: a set of “data source” components, a set of “display” components, and a set of “controlling” components. A user will typically select, in constructing an instrument, a combination of components that includes at least one component selected from each of these three principal groups: for example, a data source component representing a source of measurement data, a visualization component chosen to display, graphically or numerically, measurement data obtained from the selected data source, and a control component suitable for controlling the operation of the data source hardware. However an instrumentation application may incorporate, within a single desktop display, many more components, including components that represent software instruments for processing measurement data, such as an oscilloscope or a spectrum analyzer, and the additional control components necessary or useful to control the additional data visualization or data processing components.

The user in developing an application may thus first select a visual component, such as a virtual gauge or dial, or a non-visual component such as a comparator or a counter, and connect that component to a source of data. The data source component may provide original measurement data, or it may provide calculated data, consisting of calculation results derived from measurement data provided by yet another source of data (either currently, or consisting of previously collected and now stored measurement data).

A large variety of display components for visualizing data and a large variety of instrument controls will preferably be provided for use, including both “simple” displays that operate on arrays and single values (e.g., Meter, LED, Labels, Bar Graph), and more complex components (e.g., Oscilloscope, Line Recorder, Spectrum Analyzer, Cross Spectrum Analyzer, and Filewriter components). A set of control components will preferably include controls specific to particular display components, such a an oscilloscope controller and a line recorder controller, as well as control components having more general application, such as button controls, slider controls and the like.

In a subject-oriented development environment like Measure Foundry, the instrument components made available to users appear on the desktop as graphical representations of software objects that, “under the hood”, incorporate the potential attributes, functions and connectivities of the represented component. The desktop representation of each component is associated with a property page, readily accessible to the user, which contains the graphical tools (in the form of dialog boxes, lists of channels, etc.) needed to configure the particular component, adapt it to suit the user's requirements, and connect that component to other components (for the transport of data, the communication of a control signal, or the reporting of an event to an “event client” component).

The property page of a digital display component will thus generally comprise functionality to identify the types of data sources, including external hardware devices, available to the display component as potential sources of data, means to select a specific source of data among those which are then available to and supported by the system, and, further, means to obtain a tree view of the channel table of that data source. With a few clicks of the mouse the user may, at this point, identify and select the specific data input channel of the data source he or she has chosen to serve as a data source for the digital display component.

To make this possible the property page of each data source component placed on the desktop, say a “DAQ” component, will generally comprise functionality to locate any matching “external” data source, such as any installed data acquisition board (“DAQ board”), and to identify and present to the user the subsystems of that external data source, and the data channels carried by each of these subsystems.

Lastly, a “DAQ Controller” component will generally be provided, having a property page that presents the user with a pre-defined set of options for controlling the sampling of measurement data from the selected DAQ data source, enabling choices, for example, in sample data buffer size, and clock speed, and enabling changes in these parameters even in run time. In general, the property pages of the set of “control” components will provide for the creation of “control channels” that allow a user to change selected properties of certain other components, for example the data sampling rate, or a trigger point.

The user who is developing an application may thus, by accessing the property page of a selected “data sink” component, such as a voltage meter, connect that component to a selected data channel of an available data source, and the system will proceed to create the data links to be employed as base carriers of the resulting data streams.

The intimate interfacing of an external hardware device with the development environment software on which such a system depends is only possible because hardware vendors have developed software layers able to query their test and measurement device and adapt automatically to different channel counts, connectors, data types, and other parameters. For example, Data Translation, Inc.'s DT-Open Layers for .NET Class Library software is a set of object-oriented classes for programming Data Translation's data acquisition devices in Visual C# and Visual Basic .NET. It allows users to access the capabilities of these devices programmatically, using “classes” (symbolic representations of objects) that define the operations that objects can perform, using properties, methods, and events. Other device vendors provide comparable software resources for their products.

These software “standard layers” are usually system-driver- and DLL-(Dynamic Link Library)-based. The developer of a graphical programming environment is then enabled to write and thereby define proposed graphical components (data source, data sink, control source, and so on) that reflect these DLL functions but that also present them in user-friendly views. In the resulting “graphical programming environment”, the user only has to make certain parameter selections, using graphical tools, and the graphical programming environment takes care of the rest, such as calling the DLL functions in the right order, error handling, and so on.

In summary, a graphical programming environment for test and measurement typically comprises a set of software components that represent certain hardware device capabilities, and which as a group constitute a software layer that represents the physical world. Input connectors and software data processing components can be represented as data sources in software. Output connectors, data storage devices, and software data processing components can be represented as data sinks. (Software data processing components both receive data and emit data.) Software control sources modify the behavior of these connectors and data processors. Events track state changes.

Implementing such a software layer is comparatively straightforward if the hardware capabilities of the test and measurement device are well-defined, and always stay they same. But test and measurement devices are subject to constant change and evolution. Higher channel counts, faster clocks, more advanced modes, and more sophisticated triggers, to name but a few, are features that are constantly changing.

The development environment model described above is not well suited for adaptation to significant changes in the capabilities and functions of hardware devices. In user applications developed using such a development environment model, the user application is directly linked to a data connection, resulting in a condition known as “early binding”: that is, the user application is “locked in” to the exact capabilities defined in the software “standard layer” (representing a particular physical object) as presented by the data connection. Whenever the software standard layer changes, the data connection has to change as well, to reflect the modified software standard. This hard fact always has major implications for the user application, because the entire programming logic of the application “sits on top” of a data connection.

A second problem is that the user of such a graphical programming environment cannot integrate any function into the end user application that is not currently implemented in all underlying layers. In reality that means that the user application cannot be written before the hardware is fully developed, the driver is written, the software standard layer is changed, and the data connection is modified. For the same reason it is impossible to write or modify a user application if the hardware is not present, because the data connection needs to talk to the underlying layer in order to query the hardware.

There is accordingly a need for an improved graphical development environment that comprises a capability to adapt to significant changes in the operational characteristics of hardware devices desired to be used in applications developed using the improved development environment, and to the introduction of entirely new types of hardware data source devices.

### SUMMARY OF THE INVENTION

The present invention achieves a graphical development environment that enables the development of test and measurement applications capable of adapting to significant changes in the functionalities of hardware devices intended for use as data sources in such applications.

The improved development environment of the present invention comprises a new software layer that serves to decouple the data connection aspects of a conventional graphical development environment from the visualization, data processing and control components of such a conventional development environment.

The decoupling layer provided by the invention allows users broad discretion to define their own data acquisition virtual interface, rather than being required to use an existing data connection component directly.

The decoupling layer comprises two types of components. One component type (the “Jack”) is adapted to interface with the data connection functional unit or components of an application, and the second component type (the “Plug”) is adapted to interface with the rest of the application. A single link between a Jack and a Plug, in the form of a pointer, serves to effect a binding between two of these otherwise independent components.

Jack components are designed to permit the creation of a virtual software interface having all the desired properties, actions, and events a potential user application might use, notwithstanding the absence of any existing data connection that actually includes all of these features. However, having defined a Jack comprising a desired interface, an application developer can then map a real data connection to the Jack's data channels.

One or more Jack components having been defined, a Plug component may be defined, as the component through which a selected Jack component may communicate with the application. The Plug is configured to inherit the entire interface of the Jack to which it is connected, and then to re-create the identical interface on the application side. As a result, every component on the application side can now communicate with the Plug as a data source, a data sink, a control source, and an event source, and there is no need for any component to talk directly to a data connection on the data acquisition functional unit or components of the application.

### DESCRIPTION OF DRAWINGS

FIG. 1 is a diagram illustrating the architecture of a conventional graphical development environment.

FIG. 2 is a diagram illustrating the interplay among principal component groups in a conventional graphical development environment.

FIG. 3 is a diagram illustrating the functional positioning of a decoupling software layer in a graphical development environment.

FIG. 4 is a diagram illustrating the relative functional positioning of Jack and Plug components within the de-coupling software layer of the system of the invention.

FIG. 5 is a diagram illustrating the respective connectivities of Jack and Plug components in a system according to the invention.

FIG. 6 is a diagram illustrating a Jack-switching operation in a system according to the invention.

FIG. 7 is a diagram illustrating the separability of Plug from Jack components in certain embodiments of the invention.

### DETAILED DESCRIPTION OF THE INVENTION

The present invention discloses means for the virtualization of data sources and other components, in a graphical development environment, in order to maximize hardware interchangeability and to enable operation of simulated data source devices in an application developed using a system according to the invention.

The invention is presented and described herein in the context of a subject-oriented graphical development environment such as the Measure Foundry environment marketed by Data Translation, Inc. of Marlboro, Mass. However it is believed that other types of development environments for test and measurement applications, such as those which employ a “wiring diagram” approach to application development, may also be adapted to employ the invention.

Subject-oriented graphical programming is a superset of familiar “object-oriented programming.” Whereas object-oriented programming defines an object that inherits capabilities and characteristics from a class (and possibly one or more sub-classes), subject-oriented programming adds a layer of abstraction that defines the uses of objects individually or as a collection to assemble a construct or accomplish a task.

The components employed in a subject-oriented, graphical development environment, like the data connections in any graphical programming language, have interfaces to publish their properties and methods to the rest of the system. These interfaces are generally defined by programmers who try to mirror the functions and properties of an underlying software or hardware layer/structure. The interfaces the programmers create are dynamic—that is, they define the properties that are to be made available to the user during configuration based upon dependencies and selected choices that trigger those dependencies. A user of a graphical programming language should not be bothered with abstract programming, and should be presented with property names and functions that are specific to a particular use case and context.

In a subject-oriented graphical programming environment the control channels and properties being published with respect to external data source devices are based on the capabilities queried from a software standard layer. Only valid choices are being presented to the user. While this paradigm appears ideal for the end user, it is unfortunately and correspondingly cumbersome when it comes to hardware interchangeability.

In an ideal world, components that do similar things would have the same static interface, but that would mean that new capabilities could never be implemented (at least not without making the entire concept of inheritance accessible to the end user), and legacy code could never be removed. It would also mean that every component would always publish all properties and methods no matter which ones are physically present.

Realistically even components that do similar things typically proffer different interfaces to the outside world. A software data connection for instance would most likely publish as many properties and methods as possible to reflect the hardware's capabilities. However, “talking” to two different software data connections that mirror different hardware functions automatically leads to “early binding”. That means that the user of a conventional graphical programming environment starts designing his or her application from the data connection layer and ties all other components to the existing interfaces.

At the instant that a software data connection has been placed onto a container in a user application and has been configured, the interface is determined, and other components of the application can use only what this particular software data connection publishes. This approach works well if there is no intention to ever change the hardware being used, or if the software is intended to be used only with one software data connection, but serious difficulties arise when such is not the case.

A typical test and measurement application consists of at least four major functional units:

1. The data connections part (acquisition and output)

2. Visualization

3. Data processing, and

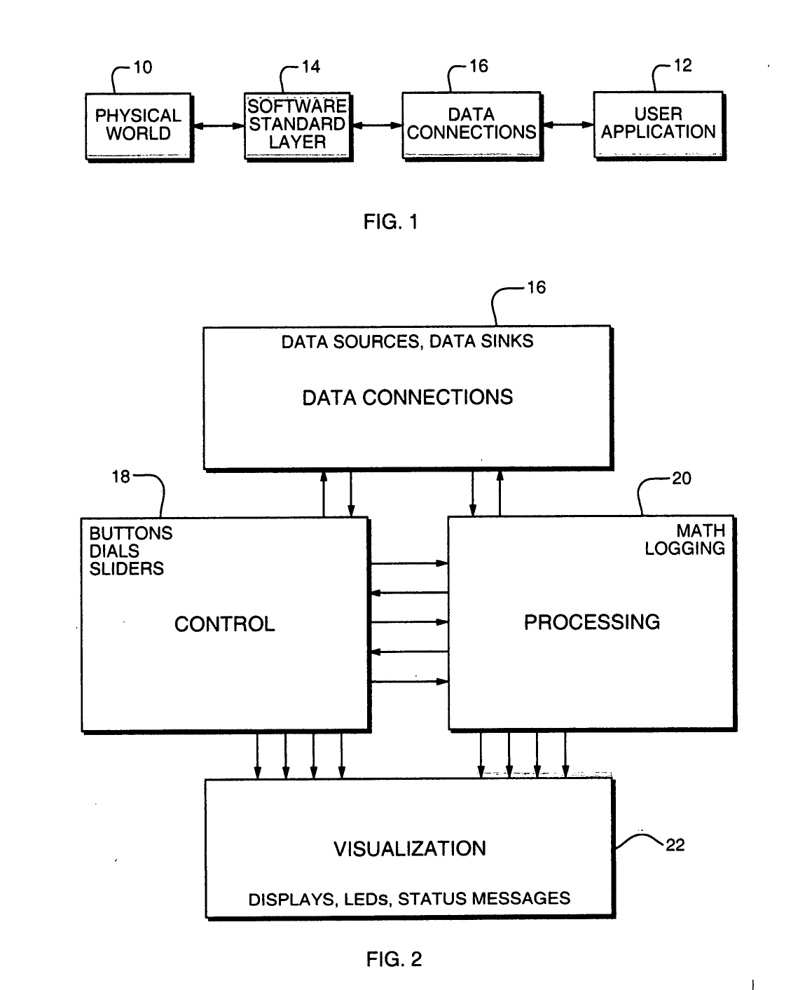

4. Control

where the data connections part may be taken to include both the data connections to the remainder of the application and also the “software standard layer”, positioned between any external hardware devices and the data connections components, that mediates between the hardware devices and the application. This general arrangement is illustrated in FIG. 1, in which box 10 entitled “physical world” represents an external hardware device, serving as a source of data for a user application 12, with “software standard layer 14” mediating the communications between the “physical world” and said user application, and data connection box 16 representing the interface between the external device and the user application.

As shown in FIG. 2, there is usually a lot of interaction among these four functional units. Also, and as illustrated, the Control 18, Processing 20, and Visualization 22 components interact more with each other than they do with Data Connections functional unit 16.

The two principal objectives of the subject oriented programming approach are separation of concerns and achieving the highest possible form of abstraction. These objectives are difficult if not impossible to realize fully when dealing with fixed interfaces. In the particular context of a development environment for test and measurement applications, it is necessary, in order to achieve full separation of concerns, to decouple the data connection part of an application completely from the part or parts that comprise the visualization, processing and control components.

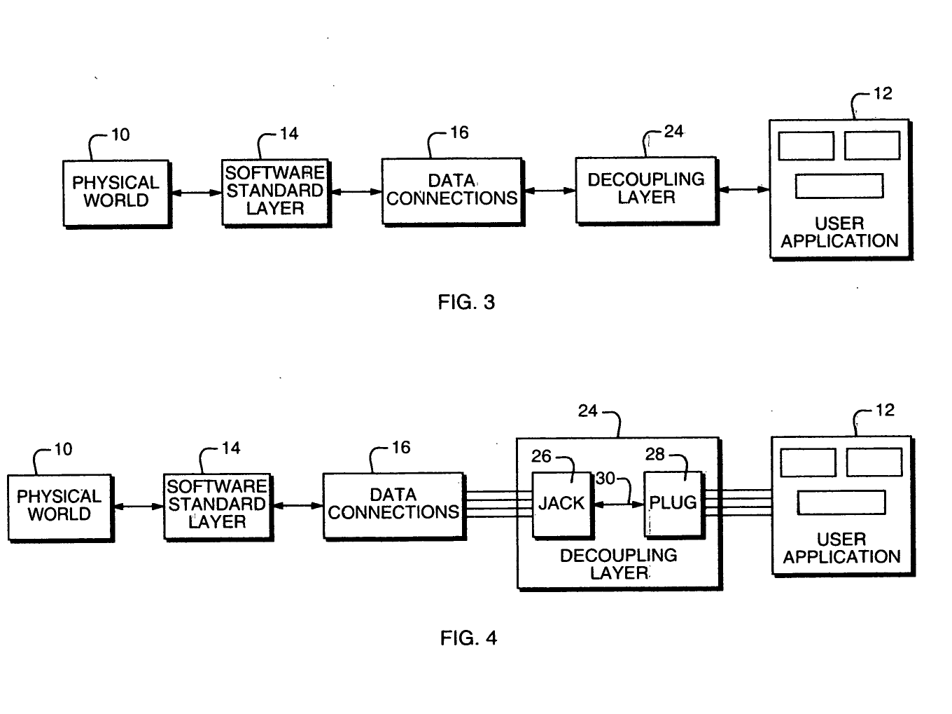

Such a de-coupling can be achieved by creating in software a decoupling layer between the actual data connection part and the rest of the application, as shown in FIG. 3, wherein a decoupling layer 24 is shown as a box positioned between application 12 and data connections unit 16.

The insertion of decoupling layer 24 into the development environment allows a user developing an application to define his or her own virtual interface, instead of using a data connection component directly. Its purpose and effect is to decouple the data connection functional part from everything else that is happening in the user application.

Referring to FIG. 4, the decoupling layer is illustrated as box 24 and comprises two independent component types. One component type (here shown as “Jack” 26) talks to the data connection functional unit, and the other one (here shown as “Plug” 28) talks to the rest of the application. In between these two components there is only a single link, pointer 30, adapted to effect the binding of a Jack component to a Plug component.

Each Jack component is designed to allow the creation of a virtual software interface that has all of the desired properties, actions, and events a potential user application might use. To satisfy this objective, each Jack component preferably has the following interfaces: bi-directional data source, bi-directional control source, and bi-directional event source. It is important to note that, in creating and configuring a Jack, a user does not refer to the data connection functional unit as its basis, but rather selects its characteristics based on the user's own current and future needs.

Once a Jack component is added to the application design, the user can start defining the interfaces, properties, actions, and events which the Jack component publishes. This interface definition should represent all hardware data source, hardware data sink, control source, and event source aspects the complete user application might use. Importantly, it is not necessary for the system then to have any data connection that actually includes any, let alone all of these features.

After defining the complete interface of a Jack, the user can map a real data connection to the data channels of that Jack. It does not matter whether or not the real data connection can map to the complete interface, and a partial match is sufficient. Also, the user can link all real control and event channels to the Jack's published control and event channels.

The next step in the process of creating a de-coupled data acquisition application is to add a “Plug” component to the application design. Typically, in presentation to users, Jack and Plug components would be subject to being configured in separate containers (such as forms or windows) in the application design, both for practical use and to visually reflect (in design mode) the decoupling of other components. The Jack component should preferably be grouped with the data connection components, and the Plug component preferably with the processing, control, and visualization components in the application design.

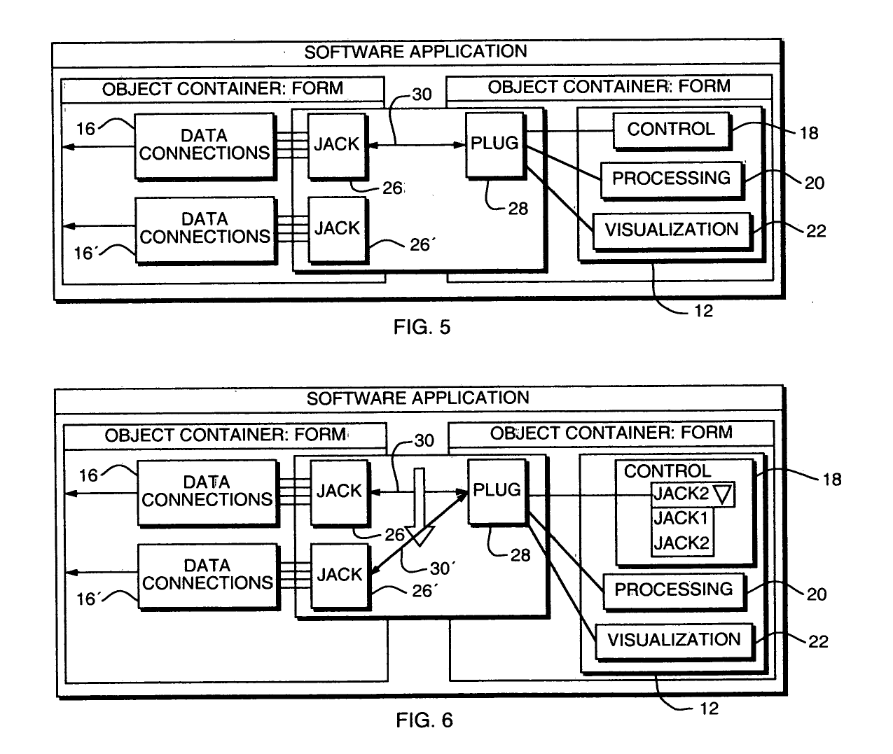

In the procedure to configure a Plug component, the first task is to select a Jack component to which the application should talk. The act of making this selection causes the Plug to inherit the entire interface from the Jack to which it is connected, and it re-creates the identical interface on the application side of the Plug. (Accordingly, two or more Plug components that inherit the same interface are identical, and two Plug components that inherit interfaces from different Jack components will not be identical). Every single component on the application side can now communicate with the Plug as a data source, a data sink, a control source, and an event source. There is no need to talk directly to a data connection on the data acquisition functional unit. The resulting relationships among these components are illustrated in FIG. 5.

Every Plug component publishes a “Connect To” property. This property contains an enumerated list of all Jack components that have a compatible interface, and, in the course of runtime, an end user of the application can hook up a control component (for example, a control list box) to control this property. Whenever this user selects a different Jack, the Plug connects to everything that is connected to the new Jack in the data acquisition functional unit. These features are illustrated in FIG. 6.

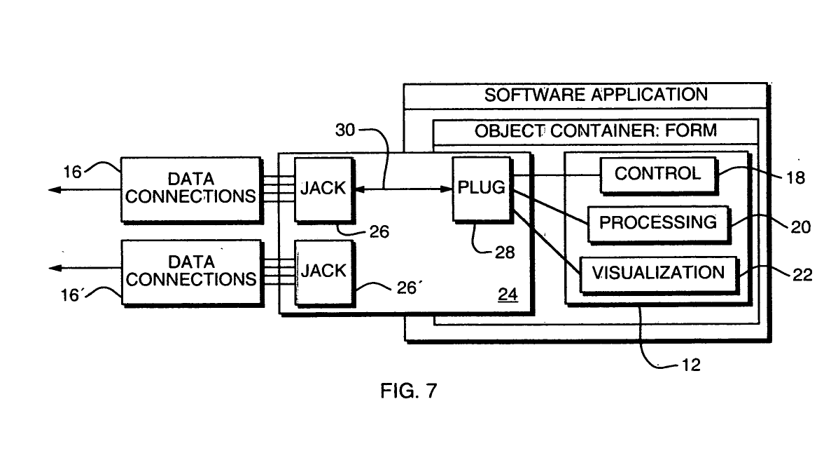

It should be understood that the Jack components and connected data acquisition components do not necessarily have to be part of the particular user application that hosts a particular, matching Plug component. As illustrated in FIG. 7, in particular, an external application that is using Component Object Model (COM) or Distributed Component Object Model (DCOM) mechanisms to connect to a host can also be used, and comprise the Jack components needed to access external hardware devices.

Without a hardware reference, the interfaces, controls, and events created by a Jack must necessarily be stored. Preferably, XML (eXtensible Markup Language) code is used to store this information in a project file, or in a separate external file that is accessed by projects through COM or DCOM. One part of the XML representation is a placeholder for the connection points where the hardware data connections are to be made, and another part is a placeholder for the Plug component connections. The XML storage may also enable capability discovery by software utility programs in the future.

External XML files that store Jack information can be used as templates. That is, once a Jack is created as a logical interface that represents one or more possible physical interface sets, it can be copied and distributed for the convenience of users. A collection or library of these predefined Jack components provides further utility, spanning the currently-available hardware from one or more vendors.

As a baseline, the library of Jack components provides logical interfaces that are directly inherited from the hardware interfaces they represent. The Jack components can then be extended to anticipate changes. As a library element, the Jack is used not only for quick configuration, but also for development where real hardware is not yet available.

The procedures to be followed by a user, to make use of the data source de-coupling features of the present invention, are very similar to the procedures described in co-pending patent application Ser. No. 10/230,412, with respect to user programming of an application in a traditional Measure Foundry development environment. This is because the newly introduced Jack and Plug components are constructed in essentially the same way as traditional Measure Foundry components (which are generally called “panels” in the referenced co-pending application).

In general, and in the same way described for Measure Foundry components in application Ser. No. 10/230,412, all of the functions made available to users, through the Jack and Plug components, have been pre-compiled in optimized code, and stored in a base function library. In addition, each Jack and Plug component has an entry in an XML-based description catalog of Jack function libraries, associated with the base function library. Thus, and as for other components in a Measure Foundry type environment, there is, for each Jack component that the user may place in a Jack and Plug Box and configure, an associated XML description that describes all of the pertinent variables, and that can be incorporated as descriptors into, for example, an Aspect Interaction Language (AIL) script of a user application.

To create and manage user applications, a development environment like Measure Foundry provides a set of utilities, and where such an environment is enhanced by the present invention, these utilities also service the Jack and Plug components. Preferably the host development environment comprises an “AIL Handler” utility adapted for receiving and parsing AIL code developed in the course of programming an application: the AIL Handler parses this AIL code, creates the objects that are described in the AIL code, sets their properties, and interconnects them. Thus, an “AIL Handler” utility, in the same way that it functions for other application components, operates to “translate” XML language descriptions of Jack and Plug functions, as selected and configured by a user, into files of corresponding pre-compiled binary, drawn by the AIL Handler from collections of pre-compiled binary functions, and libraries of associated XML descriptions.

A Measure Foundry type host application that comprises the data source di-coupling capabilities of the present invention is opened in the same manner as a traditional Measure Foundry application. On start-up the host application browses its local directory, the bin directory, and searches for dynamically loadable libraries of object code, in the form of DLLs or BPLs (the Delphi analog to DLLs), that represent available component libraries. Each component, including both traditional test and measurement components such as dials, oscilloscopes, and switches, but also any Jack component and any Plug component, represents a form of DLL/BPL, and each library has one DLU/BPL file. When the browser locates such a file, it identifies its name, and loads the file, thereby making its functionality available to the user.

A user of the present invention, having for example selected a data sink component and now needing an appropriate data source component, may select (or “grab”) a Jack and Plug set, from a tool listing of available components, and placing it on the desktop, using a conventional “drag and drop” action. This Jack and Plug set, upon being placed on the desktop (or other work surface), already comprises a fully functional data source interface, a control source interface, and an event source interface. Accordingly, the newly created Jack and Plug set has at hand, from the outset, all of the resources it will require in order to communicate with all other components in the application, including any other component already on the work surface. In particular the Jack and Plug set has the resources to effect communications between the data source standard layer interface and the remainder of the application.

The present invention is believed to be adaptable for use in graphical test and measurement development environments that employ a “wiring diagram” approach, though embodiments of the invention for such applications have not been fully defined and developed at the present time.

We claim:

1. A graphical application development software product for test and measurement applications, of the type comprising graphical tools enabling a user to build a test and measurement application adapted to interconnect physical hardware devices, as sources of test or measurement data, to virtual instruments adapted to control, process or display test or measurement data, said application development software product being characterized by the presence of a virtual data source component layer that comprises at least one jack component programmable to represent virtually at least one controllable source of data, and also mappable to represent specifically the interfaces of at least one selected test or measurement device and thereby allow bi-directional interconnection to said device, and at least one plug component adapted to provide an interface for interconnecting a said jack component with a selected set of data sink, control or event channels associated with at least one said virtual instruments, whereby said at least one jack component may selectively be linked to a said plug component.

2. The graphical application development software product of claim 1 wherein said at least one selected test or measurement device is an external hardware device.

3. The graphical application development software product of claim 1 wherein said at least one selected test or measurement device is a device created in software.

4. The graphical application development software product of claim 1 wherein said at least one selected test or measurement device is a device created in software to simulate an external hardware device.

5. A graphical test and measurement development environment, fixed upon a digital storage medium and comprising a plurality of virtual instruments, and further comprising a user-programmable software layer adapted to selectively and changeably represent a plurality of data source device capabilities and enabled to selectively effect full function bi-directional communication with at least one data source device comprising a set of such capabilities, said software layer comprising at least one user-programmable Jack component adapted to represent, selectively, a fully functional interface to any one of a plurality of said data source devices, and further comprising at least one Plug component adapted to represent, selectively, a fully functional interface interposed between said at least one Jack component and at least one of said plurality of virtual instruments.

6. The graphical test and measurement development environment of claim 5 wherein said software layer is enabled to selectively effect full function bi-directional communication with at least one data source device that is an external hardware device.

7. The graphical test and measurement development environment of claim 5 wherein said software layer is enabled to selectively effect full function bi-directional communication with at least one data source device created in software.

8. The development environment of claim 5 wherein said at least one Jack component is programmable selectively to represent the interface characteristics of a plurality of external hardware devices, and said at least one Plug component is adapted to inherit from said Jack component a matching set of interface characteristics, thereby enabling bi-directional communication between said Jack component and any of said virtual instruments that is connectable to said Plug component.

9. The development environment of claim 5 wherein said at least one Plug component may be programmed by a user of said development environment using graphical tools presented to the user in a property page on a tool window associated with a desktop graphical icon representing said Plug component.

10. A set of software components stored on digital media and collectively comprising a software layer adapted for use in a graphical test and measurement development environment comprising a selection of virtual instruments, said components including at least one Plug component associated with a graphical tool window displayed to users of said environment, and a Jack component similarly associated with a graphical tool window displayed to said users, wherein users may by accessing configuration tools presented on the property pages of said tool windows configure a said Jack component to represent an interface to a real or imagined external hardware device having specified capabilities and configure a said Plug component to represent a matching interface thereby to allow bi-directional communication of data channels, control channels and event channels between said Jack component and at least one of said virtual instruments of said environment.
